(19) United States
(12) Patent Application Publication
(10) Pub. No.: US 2019/0386532 A1
(43) Pub. Date: Dec. 19, 2019

(54) ELECTRIC MOTOR

(71) Applicant: GM GLOBAL TECHNOLOGY OPERATIONS LLC, Detroit, MI (US)

(72) Inventors: Matthew T. Vanderlip, Windsor (CA); Matthew J. Bozich, Warren, MI (US)

(21) Appl. No.: 16/010,904

(22) Filed: Jun. 18, 2018

(51) Int. Cl. H02K 1/30; H02K 1/27; H02K 15/03

(52) U.S. Cl. CPC H02K 1/30; H02K 15/03; H02K 1/276

(57) ABSTRACT

An electric machine includes a stator and a rotor lamination assembly. The rotor lamination assembly may be configured and disposed relative to the stator. The rotor lamination assembly includes at least one lamination member wherein the lamination member defines at least magnet receiving aperture and a fastening region. The lamination member further includes a body disposed between an inner diametric edge and an outer diametric edge. The magnet receiving aperture includes a first end which extends to a second end such that the second end is spaced from the outer diametric edge to define a bridge region. The fastening region engages with a receiving region in a rotor shaft via an interference fit to generate a tensile load (or pre-load) in the body.

### TECHNICAL FIELD

This present disclosure relates generally to an electric motor, and more particularly, to a rotor lamination assembly for a permanent magnet electric machine.

### BACKGROUND

Electric machines include a rotor that sets up a magnetic field. Electrical current passing through a stator is influenced by the magnetic field creating an electro-motive force that causes the rotor to spin. Certain electric motors/generators employ permanent magnets in the rotor. The permanent magnets are mounted in magnet slots formed in the rotor, which is typically formed from a plurality of laminations. Generally, the permanent magnets are mounted near an outside edge of the rotor, as close to the outside edge as possible, in order to maximize torque and minimize losses. Mounting the permanent magnets in this manner creates a thin bridge area between the magnet slots and the outside edge of the rotor.

During high speed operation, centrifugal forces on the rotor create stress in the thin bridge area as well as in the web neck regions. If operated at too high a speed, the stress can exceed the yield strength of the laminations. In such a case, the rotor could fail. Accordingly, there is a trade-off between structural stability and high speed operation. That is, the desire to maintain the structural integrity of the rotor (which holds the magnets proximate to the edge of the lamination) limits the operational speed of the electrical machine.

In recent years, the drive for energy efficiency and low cost motors has led to development of many types of electric motors and generators for various applications. Among the electric motors, permanent magnet synchronous motors (PMSM) are known to have high power density and efficiency. An interior permanent magnet (IPM) motor, which is a specific type of PMSM and also called permanent magnet reluctance (PMR) motor because of its hybrid ability to produce reluctance torque as well as permanent magnet torque, is one of the most prevalent types. A PMR motor includes a rotor having one or more permanent magnets embedded therein and generates a higher torque than a motor with a surface mounted magnet rotor. It is because the permanent magnets are positioned in the rotor core in such a way as to provide saliency in the magnetic circuit in the rotor core, which produces an additional reluctance torque.

However, during operation, each magnet embedded in the rotor core is subject to centrifugal force. In order to retain the magnets within the rotor core under the centrifugal force and also minimize flux leakage to other poles within the rotor core, narrow sections of rotor core material are often retained between the ends of a magnet pole and the outer periphery of the rotor core. These narrow sections are often called “bridges” or bridge areas. FIG. 1 shows a schematic cross-sectional view of a conventional IPM motor 210 with magnets disposed in the rotor core. As depicted, the motor 210 includes a stator core 211 having a hollow cylindrical ring 220 and a core portion 215 formed inside the ring 220. The core portion 215 has slots 212 punched therethrough and coils 214 are wound around the slots 212. The motor 210 also includes a cylindrical rotor core 216 disposed on the inner side of the stator core 211, wherein a plurality of holes 218 are formed in the rotor core. Each hole 218 corresponds to a pole, extends through in the axial direction, and has a U-shaped cross section. Three permanent magnets 226 are inserted in each hole 218. Reference numeral 222 represents a magnetic-flux holding portion or center pole section of the rotor lamination that is located on the radially outward side of the hole 218. Numeral 224 represents a bridge that is disposed between the end of a magnet hole 218 and the outer periphery of the rotor 216, Reference numeral 228 denotes the rotor shaft.

During operation, the centrifugal force acting on the permanent magnets 226 and the centrifugal force acting on the center pole section 222 are concentrated in the bridges 224 and web necks 224 of the rotor core 216. For this reason, the radial width of the bridges 224 and web necks 224 must be large enough to maintain the required mechanical strength. However, the amount of magnetic flux leakage through the bridges and web necks 224 may be compromised with the mechanical strength of the rotor core under the centrifugal forces imparted by rotation. It is desirable for bridges and web necks 224 to be relatively thin to reduce flux leakage. However, thinner bridges and web necks lead to a reduction in rotor strength which can then limit the speed capability of the motor 210.

Therefore, it is desirable to increase the rotational speed capability of motors while at the same time maintaining the structural integrity of the rotor at the bridges, web necks and magnets despite centrifugal forces acting on these components and/or regions.

### SUMMARY

The present disclosure provides for an electric machine having a robust rotor lamination assembly having a tensile pre-load which increases the mean-stress in the web so that, at high rotor speeds, the stress amplitude is minimized. Accordingly, the fatigue life of the material is improved thereby making the lamination assembly more robust to repeated high-speed cycles. The electric machine includes a stator and a rotor lamination assembly wherein the rotor lamination assembly may be configured and disposed relative to the stator. The rotor lamination assembly includes at least one lamination member wherein the lamination member further includes a body having an inner diametric edge that extends to an outer diametric edge. The lamination member defines one or more magnet receiving apertures proximate to the outer diametric edge and a fastening region defined along the inner diametric edge. The fastening region engages with a receiving region in a rotor shaft or hub to generate a tensile load in the body. Each magnet receiving aperture includes a first end which extends to a second end such that the second end is spaced from the outer diametric edge to define a bridge region. The centrifugal stress at issue is located, in particular to the regions of the body proximate to the permanent magnets—that is, the bridge regions and the web necks defined in each lamination.

The rotor lamination assembly includes at least one lamination member wherein the lamination member further defines a body having an inner diametric edge that extends to an outer diametric edge. The lamination member or lamination defines one or more magnet receiving apertures proximate to the outer diametric edge and a fastening region defined along the inner diametric edge. Each fastening region engages with a receiving region in a rotor shaft to generate a tensile pre-load in the body. Each magnet receiving aperture includes a first end which extends to a second end with an intermediate region disposed in between. The second end of a magnet receiving aperture is spaced from the outer diametric edge to define a bridge region.

In the non-limiting examples provided in FIGS. 3-4, the tensile load or preloads are distributed over the body of each lamination in a radial direction proximate to each engagement region. The tensile load (or tensile pre-load) is configured to generate a negative hoop stress and is therefore, configured to increase the mean stress in the lamination as well as also reduce the stress amplitude when the rotor assembly is operating at a high speed. Therefore, the stress amplitude is reduced at each web neck and at each bridge region defined in the body.

In another embodiment of the present disclosure, a method of forming a high-speed rotor lamination or lamination member is provided. An example non-limiting method includes the steps of; (1) forming a lamination member 20 defined by an inner diametric edge, an outer diametric edge and a body defined therebetween, the inner diametric edge further defining a fastening region over at least a portion of the inner diametric edge; (2) defining at least one magnet receiving aperture in the body, at least one magnet receiving aperture including a first end, a second end and an intermediate region therebetween, the second end being spaced from the outer diametric edge to form a bridge region; (3) engaging the fastening region of the lamination member with a receiving region of a rotor shaft or hub via an interference fit; and (4) generating a tensile pre-load in the body of the lamination member.

It is understood that the step of defining each magnet receiving aperture includes the step of defining a plurality of magnet receiving apertures in the body proximate to and along the outer diametric edge of each lamination. It is also understood that the aforementioned method includes the step of defining the plurality of magnet receiving apertures in groups proximate to and along the outer diametric edge and the tensile load being aligned with a central web neck for each group.

### BRIEF DESCRIPTION OF THE DRAWINGS

These and other features and advantages of the present disclosure will be apparent from the following detailed description, best mode, claims, and accompanying drawings in which:

FIG. 1 illustrates a schematic, cross-sectional view of a traditional electric motor.

FIG. 2 is an example, cross-sectional view of an electric motor according to various embodiments of the present disclosure.

FIG. 3 is a schematic, plan view of a first example, non-limiting rotor assembly of the present disclosure—without the magnets installed,

FIG. 4 is a schematic, plan view of a second example, non-limiting rotor assembly of the present disclosure—without the magnets installed.

FIG. 5 is a schematic, partial view of a third example, non-limiting rotor assembly of the present disclosure.

FIG. 6 is a schematic, partial view of a fourth example, non-limiting rotor assembly of the present disclosure.

FIG. 7A is a schematic, partial view of the rotor assembly in FIG. 3 where the magnets are installed.

FIG. 7B is a schematic, partial view of another embodiment of the present disclosure wherein coupling members are disposed between each lamination and the shaft/hub.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

The terms “upper” and “lower” may be used with respect to regions of a single component and are intended to broadly indicate regions relative to each other wherein the “upper” region and “lower” region together form a single component. The terms should not be construed to solely refer to vertical distance/height.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

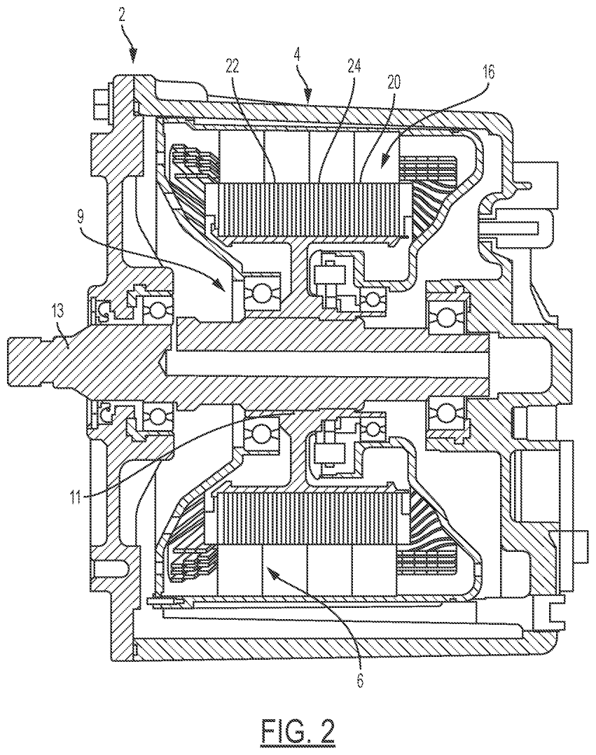

Referring to FIG. 2, an electric machine constructed in accordance with an exemplary embodiment is indicated generally at 2. Electric machine 2 includes a housing 4 having mounted thereto a stator 6. A rotor assembly 8 rotates relative to stator 6 to produce an electro-motive force. In the exemplary embodiment shown, rotor assembly 8 includes, but is not limited to a hub portion 11 having mounted thereto a shaft 13. Rotor assembly 8 also includes a rotor lamination assembly 16 which are mounted on hub portion 11, The lamination assembly 16 may also be mounted directly to a rotor shaft along with other components of the rotor assembly 16 as later described herein. The rotor lamination assembly 16 is formed from a plurality of lamination members, one of which is indicated at 20.

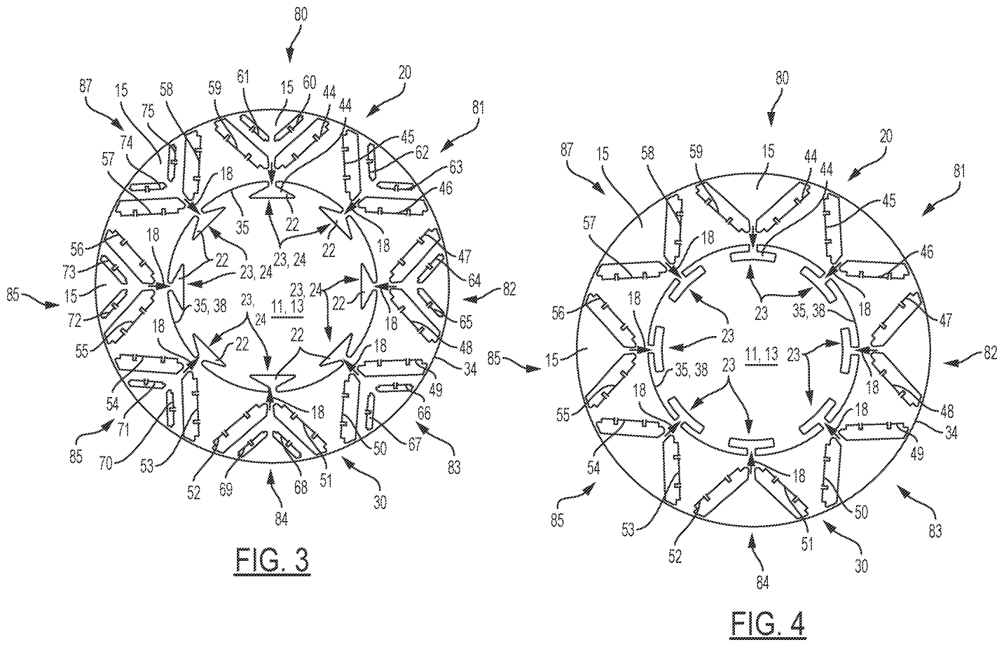

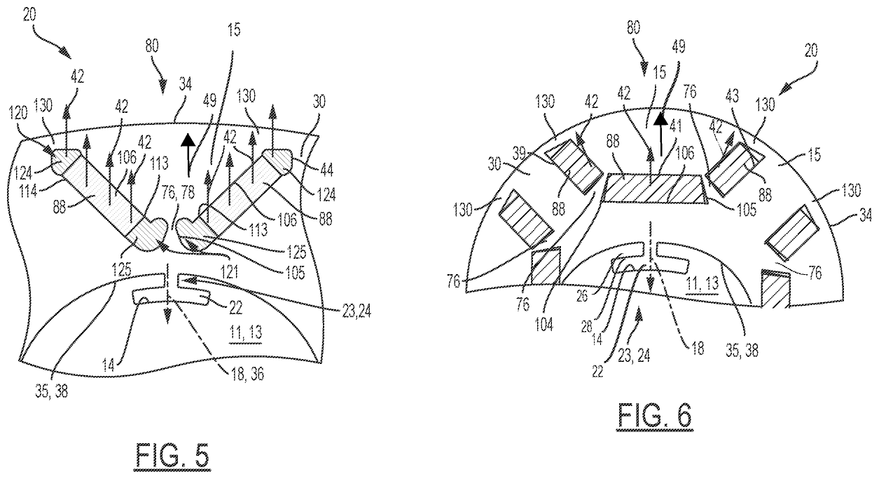

Reference will now be made to FIG. 3 in describing lamination member 20 in accordance with a first non-limiting, example embodiment. Lamination member 20 includes a body 30 having an outer diametric edge 34, and an inner diametric edge 35 that defines a rotor hub receiving portion 38. Outer diametric edge 34 is spaced from inner diametric edge 35 through a web portion 40 (or body 30), As shown FIG. 3, lamination member 20 includes a plurality of magnet receiving apertures 44-75 arranged about outer diametric edge 34. More specifically, in the non-limiting example shown in FIG. 3, the magnet receiving apertures 44-75 are arranged in groups 80-87 of four (shown as elements 80-87) which are spaced annularly about outer diametric edge 34. However, it is understood that the magnet receiving apertures 44-59 may also be arranged in groups 80-87 of two (see FIGS. 4 and 5), three (see elements 39, 41, 43 in FIG. 6) or other numbers as well. Each magnet receiving aperture 44-75 is configured and disposed to accept a corresponding one of a plurality of magnets 88. Magnetic flux may flow through center pole regions 15 in the various non-limiting examples shown in FIGS. 3-7B.

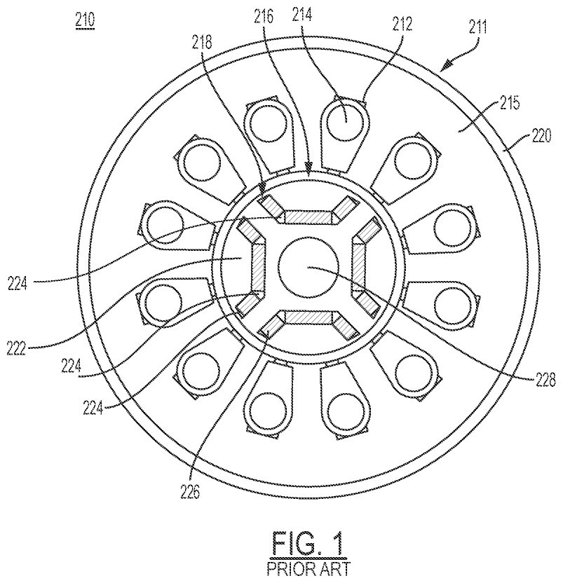

Referring again to FIGS. 3-7B, in order to reduce the risk of stresses from the centrifugal force 42 exceeding the yield strength of the lamination which support the plurality of magnets 88 within each group 80-87, a fastening region 22 of each lamination 20 may engages with a receiving region 14 defined in the rotor hub 11 (or shaft 13) via an interference fit 24 wherein the engagement of the fastening region 22 with the receiving region 14 generates a tensile pre-load 18 (negative hoop stress) in the body 30 proximate to the engagement region 23. The tensile pre-load 18 is configured to increase the mean stress in the lamination as well as also reduce the stress amplitude when the rotor assembly is rotating at a high speed. Given that the lamination is pre-tensioned to a high value which is close to the lamination material's yield strength S_{y} (such as, but not limited to 400 MPa for lamination steel), the stress imposed on each lamination will either remain fixed (for example, fixed at 400 MPa) or will cycle within a much smaller range. It is understood that in the traditional rotor core shown in FIG. 1 (without a tensile pre-load), the laminations in the traditional rotor core experience stresses which may cycle between 0 MPa and the material's Yield Strength (S_{y}) (ex: 400 MPa) each time the rotor speeds up. Accordingly, due to the fixed stress or smaller cycling range of the stress, the rotor assembly 8 of the present disclosure can withstand a high number of high speed cycles thereby improving robustness. The present disclosure therefore provides an electric motor with a rotor assembly in which the stress remains relatively static and/or does not vary over a wide range.

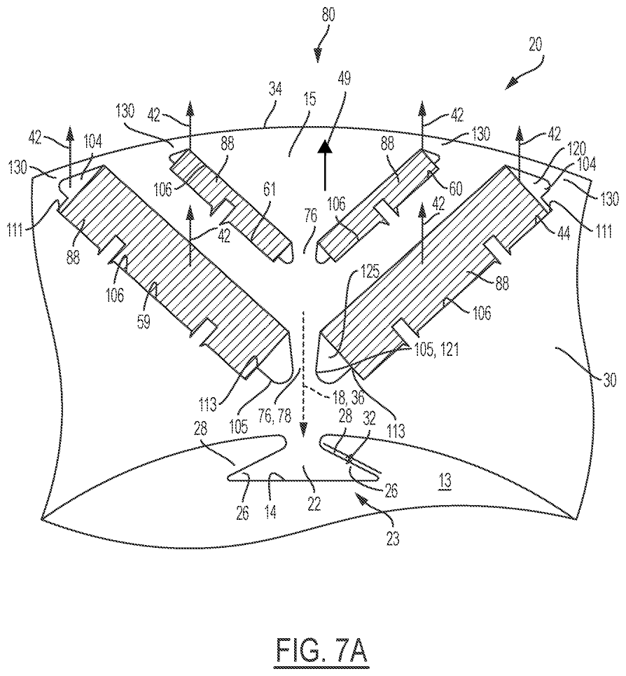

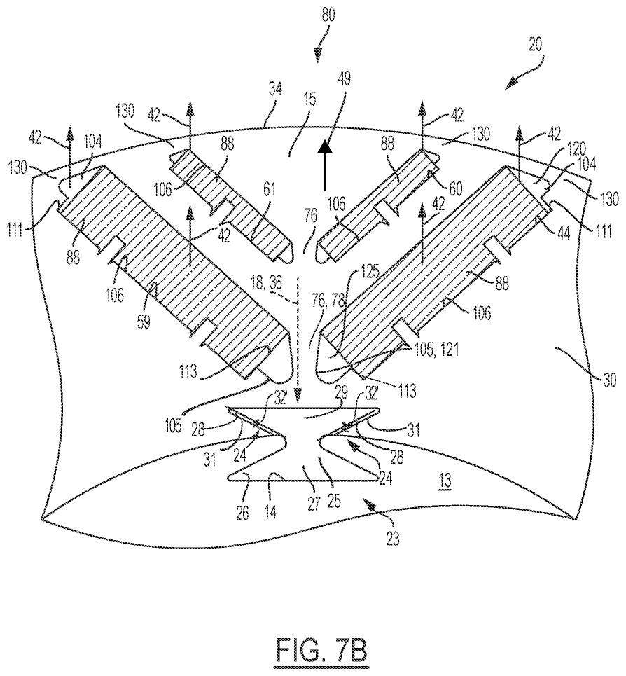

Engagement region 23 may generally be defined as the region where the fastening region 22 of each lamination 20 engages with the rotor assembly 8 (such as but not limited to rotor hub 11, rotor shaft 13, or coupling member 25) such that a tensile pre-load 18 is imposed on each lamination 20 due to an interference fit between the lamination and a component of the rotor assembly 8. Thus, in the non-limiting examples of FIGS. 3-7A, the engagement region 23 is formed by the fastening region's 22 engagement with a receiving region 14 of the rotor hub 11 or rotor shaft 13—depending on whether the lamination assembly 16 is mounted on the hub 11 or rotor shaft 13. In order to provide an interference fit 24 at each example engagement region 23, it is understood that a lower edge 26 of the receiving region 14 extends beyond an upper edge 28 of the fastening region 22 by a predetermined distance 32 (see FIG. 7A), such as but not limited to 0.025 mm to 0.045 mm for a lamination 20 using typical lamination steel. It is understood that the interference fit and/or predetermined distance 32 is generally selected to target a pre-tension stress/load 18 close to the yield strength of the lamination material while still accounting for manufacturing tolerances. The yield strength for the material used for the rotor hub/rotor shaft 11, 13 is generally much higher than that of the lamination material. In the non-limiting example of the present disclosure where lamination steel is used for the laminations, an example non-limiting yield strength may be about 400 MPa. However, it is understood that various yield strengths for the laminations 20 may be used which fall in the range from about 250 MPa to 500 MPa.

However, as shown in the additional non-limiting example of FIG. 7B, the engagement region 23 may also be formed by the fastening region's 22 engagement with a coupling member 25 or a plurality of coupling members 25 wherein the coupling member(s) 25 may be disposed between each lamination 20 and the rotor hub 11 or rotor shaft 13. The coupling member(s) 25 may be configured to fit within the receiving region 14 of the rotor hub/shaft 11, 13 at a rotor side 27 of the coupling member(s) 25 and configured to have an interference fit 24 with fastening region(s) 22 of lamination 20 at a lamination side 29 of the coupling member(s) 25. The interference fit 24 in FIG. 7B occurs by having each lower edge 31 of coupling member 25 extend beyond each corresponding upper edge 28 of fastening region 22 by a pre-determined distance 32′ such that the fastening region 22 (and lamination 20) experiences a tensile pre-load 18 upon engaging with the lamination side 29 of coupling member 25. Similar to the examples in FIGS. 3-7A, the predetermined distance 32′ may, but not necessarily, fall within a range of about 0.025 mm to about 0.045 mm for a lamination 20 using typical lamination steel. Similar to the previous examples, it is understood that the interference fit 24 and/or predetermined distance 32 is generally selected to target a pre-tension stress/load 18 close to the yield strength of the lamination material while still accounting for manufacturing tolerances. The yield strength for the material used for the rotor hub/rotor shaft 11, 13 is generally much higher than that of the lamination material. In the non-limiting example of the present disclosure where lamination steel is used for the laminations, an example non-limiting yield strength may be about 400 MPa. However, it is understood that various yield strengths for the laminations 20 may be used which fall in the range from about 250 MPa to 500 MPa.

Referring back to FIGS. 3-7B collectively, as each magnet receiving aperture (see elements 39, 41, 43 and elements 45-75) is similarly formed, a detailed description will follow with reference to FIG. 5 in describing magnet receiving aperture 44 with an understanding that the remaining magnet receiving apertures 39, 41, 43, 44, 45-75 (in FIGS. 3-4, and 6-73) each include similar structures. Thus, as shown in FIG. 5, magnet receiving aperture 44 may include a first end 104 that extends to a second end 105 through an intermediate portion 106. Magnet receiving aperture 44 includes a first magnet retaining member 111 arranged proximate to first end 104 and a second magnet retaining member 113 arranged proximate to second end 105. First and second magnet retaining members 111 and 113 are configured to position magnet 88 within magnet receiving aperture 44. As shown, a first void 120 may be established between first end 104 and magnet 88, and a second void 121 is established between second end 105 and magnet 88. Each void 120 and 121 is provided with a corresponding filler material 124 and 125. In accordance with an aspect of the exemplary embodiment, filler 124 and 125 is formed from injected plastic that not only holds magnet 88 in magnet receiving aperture 44 but, when combined with other lamination members 20, also prevents oil from entering into lamination assembly 16 (see FIG. 2).

First end 104 of magnet receiving aperture 44 is spaced from outer diametric edge 34 forming a bridge region 130. Bridge region 130 is typically formed to be as thin as possible so as to reduce magnetic flux losses from lamination assembly 16. However, as indicated, the thickness of bridge region 130 places limits on an overall operational speed envelope of electric machine 2. More specifically, if bridge region 130 is formed to be so thin as to reduce most if not all losses; electric machine 2 cannot be operated at speeds above, for example 5,000 rpm. When operated at such speeds, centrifugal forces 42 are imposed on the rotor lamination assembly 16. If the stresses exceed the yield strength (S_{y}) of the lamination body 20, then the lamination could fail. create Therefore, in order to reduce the stress amplitude (schematically represented as element 49 in FIGS. 5-7B) and keep the stress 18 substantially fixed—thereby enabling the electric machine 2 to operate at speeds above 5000 rpm, lamination member 20 includes a plurality of engagement regions 23 (see FIGS. 3-4) along the inner diametric edge 35 (see FIGS. 3-4) wherein each engagement region generates a tensile pre-load 18 when each fastening region 22 engages with each receiving region 14 of the rotor shaft 13. It is understood that the engagement region 23 is defined by the regions where each fastening region 22 in the lamination 20 engages with a corresponding receiving region 14 in the rotor shaft 13. Therefore, engagement regions 23 are defined about the “rotor shaft 13 to lamination 20” interface.

Therefore, the present disclosure provides for an electric machine 2 (FIG. 2) having a robust rotor lamination assembly 16 having a tensile pre-load 18 which offsets centrifugal loads 42 imposed on the lamination assembly 16 when the rotor assembly 8 is rotating at high speeds. The centrifugal stress 42 at issue is located, in particular to the regions of the body 30 proximate to the permanent magnets 88—that is, the bridge regions 130 and the web necks 76. The electric machine 2 includes a stator 6 and a rotor lamination assembly 16 wherein the rotor lamination assembly 16 may be configured and disposed relative to the stator 6. The rotor lamination assembly 16 includes at least one lamination member 20 wherein the lamination member 20 further defines a body 30 having an inner diametric edge that extends to an outer diametric edge. The lamination member 20 or lamination 20 defines one or more magnet receiving apertures 39, 41, 43, 44, 45-75 proximate to the outer diametric edge 34 and a fastening region 22 defined along the inner diametric edge 35. Each fastening region 22 engages with a receiving region 14 in a rotor shaft 13 to generate a tensile load 18 in the body 30. Each magnet receiving aperture 39, 41, 43, 44, 45-75 includes a first end 104 which extends to a second end 105 with an intermediate region 106 disposed in between. The second end 105 of a magnet receiving aperture 39, 41, 43, 44, 45-75 is spaced from the outer diametric edge 34 to define a bridge region 130.

In the non-limiting examples provided in FIGS. 3-4, the tensile load 18 or preloads 18 are distributed over the body 30 of each lamination 20 in a radial direction 36 proximate to each engagement region 23. The tensile load 18 (or tensile pre-load) is configured to generate a negative hoop stress and is therefore, configured to reduce overall stress (shown as the combination of centrifugal load 42 and tensile pre-load 18) applied to the body 30 when each lamination 20 and each magnet 88 are moving as part of the rotating rotor assembly 8. Therefore, the overall stress is reduced at each web neck 76 and at each bridge region 130 defined in the body 30.

In another embodiment of the present disclosure, a method of forming a high-speed rotor lamination or lamination member 20 is provided. An example non-limiting method includes the steps of: (1) forming a lamination member 20 defined by an inner diametric edge 35, an outer diametric edge 34 and a body 30 defined therebetween, the inner diametric edge 35 further defining a fastening region 22 over at least a portion of the inner diametric edge 35; (2) defining at least one magnet receiving aperture in the body 30, the at least one magnet receiving aperture 39, 41, 43, 44, 45-75 including a first end 104, a second end 105 and an intermediate region 106 therebetween, the second end 105 being spaced from the outer diametric edge 34 to form a bridge region 130; (3) engaging the fastening region 22 of the lamination member 20 with a receiving region 14 of a rotor shaft 13 via an interference fit 24; and (4) generating a tensile pre-load 18 in the body 30 of the lamination member 20.

It is understood that the step of defining each magnet receiving aperture 39, 41, 43, 44, 45-75 includes the step of defining a plurality of magnet receiving apertures 39, 41, 43, 44, 45-75 in the body 30 proximate to and along the outer diametric edge 34 of each lamination 20. It is also understood that the aforementioned method includes the step of defining the plurality of magnet receiving apertures 39, 41, 43, 44, 45-75 in groups 80-87 proximate to and along the outer diametric edge 34 and the tensile load 18 being aligned with a central web neck 78 (see FIGS. 5 and 7) for each group 80-87.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An electric machine comprising:
a stator; and
a rotor lamination assembly configured and disposed relative to the stator; the rotor lamination assembly further comprising:
at least one lamination including a body having an inner diametric edge that extends to an outer diametric edge; and
at least one magnet receiving aperture defined in the body and including a first end which extends to a second end, the second end being spaced from the outer diametric edge to define a bridge region;
wherein the at least one lamination member includes a fastening region configured to engage with a receiving region defined in a rotor assembly and generate a tensile load in the body.

2. The electric machine according to claim 1, wherein the fastening region of the at least one lamination engages with the receiving region of the rotor assembly via an interference fit at an engagement region.

3. The electric machine according to claim 2, wherein a lower edge of the receiving region extends beyond an upper edge of the fastening region by a predetermined distance which falls within the range of about 0.025 mm to 0.045 mm.

4. The electric machine according to claim 2, wherein the fastening region is defined along the inner diametric edge of the at least one lamination.

5. The electric machine according to according to claim 2, wherein the tensile load is less than the yield strength of the at least one lamination.

6. The electric machine according to claim 4, wherein the tensile load is distributed over the body of the at least one lamination in a radial direction.

7. The electric machine according to claim 5, wherein the tensile load is configured to reduce a stress amplitude experienced by the body when the at least one lamination and the at least one magnet is rotating at high speeds.

8. The electric machine according to claim 7 wherein a centrifugal force is applied to the at least one lamination.

9. A method of forming a high-speed rotor lamination member, the method comprising:
forming a lamination member defined by an inner diametric edge, an outer diametric edge and a body defined therebetween, the inner diametric edge further defining a fastening region over at least a portion of the inner diametric edge;
defining at least one magnet receiving aperture in the body, the at least one magnet receiving aperture including a first end, a second end and an intermediate region therebetween, the second end being spaced from the outer diametric edge to form a bridge region;
engaging the fastening region of the lamination member with a receiving region of a rotor assembly via an interference fit; and
generating a tensile pre-load in the body of the lamination member

10. The method as defined in claim 9 wherein the step of defining at least one magnet receiving aperture includes the step of defining a plurality of magnet receiving apertures in the body proximate to and along the outer diametric edge.

11. The method as defined in claim 10 further comprising the step of defining the plurality of magnet receiving apertures in groups proximate to and along the outer diametric edge and the tensile load being aligned with a central web neck for each group.
